(19) United States
(12) Patent Application Publication
(10) Pub. No.: US 2026/0220179 A1
(43) Pub. Date: Jul. 30, 2026

(54) INFORMATION PROCESSING APPARATUS, INFORMATION PROCESSING METHOD, AND COMPUTER-READABLE RECORDING MEDIUM STORING A PROGRAM

(71) Applicant: Kabushiki Kaisha Toshiba, Kawasaki-shi (JP)

(72) Inventors: Hiroko FUJII, Komae (JP); Tomohiro YAMASAKI, Bunkyo (JP); Makoto YAJIMA, Tachikawa (JP); Pengju GAO, Komae (JP)

(73) Assignee: Kabushiki Kaisha Toshiba, Kawasaki-shi (JP)

(21) Appl. No.: 19/430,836

(22) Filed: Dec. 23, 2025

(30) Foreign Application Priority Data
Jan. 29, 2025 (JP) 2025-012610

(51) Int. Cl. G06F 16/338; G06F 16/31

(52) U.S. Cl. CPC G06F 16/338; G06F 16/322

(57) ABSTRACT

According to one embodiment, an information processing apparatus that processes conversation data, includes (a)a first selection unit configured to select at least one of the plurality of pieces of conversation data, (b)a second selection unit configured to select related conversation data different from and associated with the conversation data selected by the first selector, (c)an extraction unit that extracts a feature corresponding to a predetermined feature label from the selected conversation data and the related conversation data, (d)a specification unit configured to specify the feature for each of the feature label, (e)a display control unit configured to cause a display unit to display the feature with an appearance different for each of the feature label, and (f)a storage unit configured to store the conversation data, the feature, and the feature label.

### CROSS-REFERENCE TO RELATED APPLICATION(S

This application is based upon and claims the benefit of priority from Japanese Patent Application No. 2025- 012610, filed January 29, 2025, the entire contents of which are incorporated herein by reference.

### FIELD

Embodiments described herein relate generally to an information processing apparatus, method, and a computer-readable recording medium storing a program for processing conversation data.

### BACKGROUND

In recent years, electronic mail, chat, messages, and the like are generally used as communication tools. For example, important documents selected from conversation data in the communication tool are organized as recorded documents. There are many pieces of conversation data that are not recorded documents, and efficiency is expected to be improved by effectively using such information. However, if conversation data is used as a search target instead of a recorded document and related conversation data is simply connected and displayed at the time of display, it is difficult to understand the correspondence relationship between the conversation data and the related conversation data related thereto.

### BRIEF DESCRIPTION OF THE DRAWINGS

FIG. 1 is a schematic diagram illustrating a configuration of an information processing apparatus according to a first embodiment.

FIG. 2 is a functional configuration diagram of the information processing apparatus according to the first embodiment.

FIG. 3 is a schematic diagram showing a structure of an extraction unit of the information processing apparatus according to the first embodiment.

FIG. 4 is an example illustrating configuration information of feature information according to the first embodiment.

FIG. 5 is a flowchart showing an information processing method using the information processing apparatus according to the first embodiment.

FIG. 6 is a diagram showing a configuration example of conversation data information according to the first embodiment.

FIG. 7A and 7B are illustrations of a first display method of the information processing method according to the first embodiment.

FIG. 8 is a diagram illustrating a generation example of a second display method of the information processing method using the information processing apparatus according to the first embodiment.

FIG. 9 is a diagram illustrating the first display method and the second display method of an information processing method using the information processing apparatus according to the first embodiment.

FIG. 10A and 10B are flowcharts of creation of the first display method and the second display method of an information processing method using the information processing apparatus according to the first embodiment.

FIG. 11 is a functional configuration diagram of an information processing apparatus according to a second embodiment.

FIG. 12 is a flowchart showing an information processing method using an information processing apparatus according to the second embodiment.

### DETAILED DESCRIPTION

In general, according to an aspect of the invention, there is provided an information processing apparatus that processes conversation data, includes (a)a first selection unit configured to select at least one of the plurality of pieces of conversation data, (b)a second selection unit configured to select related conversation data different from and associated with the conversation data selected by the first selector, (c)an extraction unit that extracts a feature corresponding to a predetermined feature label from the selected conversation data and the related conversation data, (d)a specification unit configured to specify the feature for each of the feature label, (e)a display control unit configured to cause a display unit to display the feature with an appearance different for each of the feature label, and (f)a storage unit configured to store the conversation data, the feature, and the feature label.

Hereinafter, embodiments of the present invention will be described with reference to the drawings. The drawings are schematic or conceptual, and the relationship between the thickness and width of each portion, the ratio of the sizes between portions, and the like are not necessarily the same as the actual ones. Even when the same portion is illustrated, the dimensions and ratios may be illustrated differently depending on the drawings. In the specification and the drawings, the same reference numerals are given to the same elements as those described above with reference to the drawings that have already been referred to, and detailed description thereof will be omitted as appropriate.

### First Embodiment

Hereinafter, embodiments of the present invention will be described. In the specification and the drawings, the same reference numerals are given to the same elements as those described above, and detailed description thereof will be appropriately omitted.

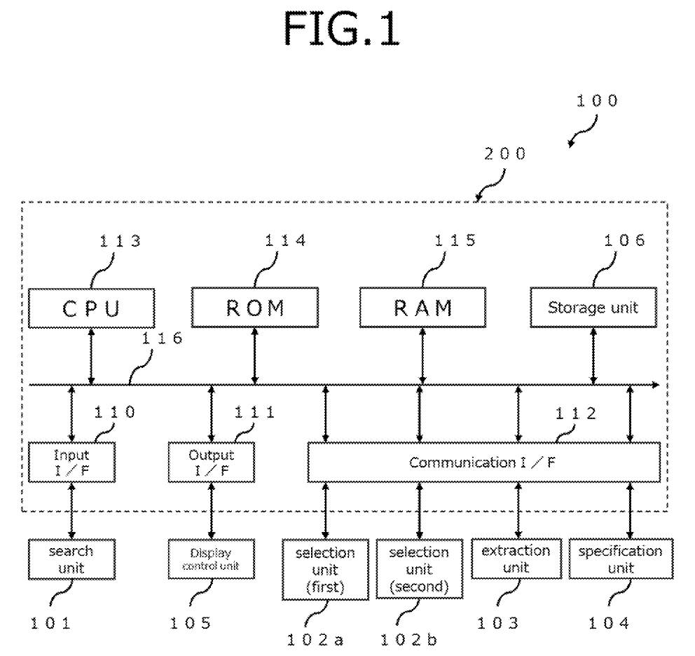

FIG. 1 is a schematic diagram illustrating a configuration of an information processing apparatus according to a first embodiment. In the first embodiment, it is considered that the electronic mail exchanged in relation to the trouble that has occurred in the business is searched, and the description of the trouble that has occurred in the business described in the electronic mail designated by the user and the related mail is extracted as the feature and visualized. However, the embodiment related to the trouble that has occurred in the business is an example, and the present embodiment is applicable to a case related to other conversation data. Each feature can be assigned a feature label (for example, "phenomenon", "cause", "countermeasure", and "result of countermeasure").

As a method of extracting a feature from conversation data, a named entity recognition method as described in Non-Patent Document (Sheng Zhang, Hao Cheng, Jianfeng Gao, Hoifung Poon, Optimizing Bi-Encoder for Named Entity Recognition via Contrastive Learning, ICLR2023, 23rd Feb. 2023) may be used. In the present embodiment, it is possible to extract a feature corresponding to a feature label by referring to conversation data. The feature refers to a text corresponding to a feature label extracted from conversation data by using a feature extraction model learned from learning data that exemplifies a set of a feature label and a feature. For example, in the case of conversation data related to a trouble, feature labels "phenomenon", "cause", "countermeasure", and "result of countermeasure" are set. A feature corresponding to a predetermined feature label is learned as learning data, the feature is extracted from conversation data, and a feature label corresponding to the feature is specified. For example, as the feature related to the feature label of "phenomenon", there are "increase in processing time", "error occurrence", and the like. The feature label can be set by the operator by adding or deleting the feature label as appropriate.

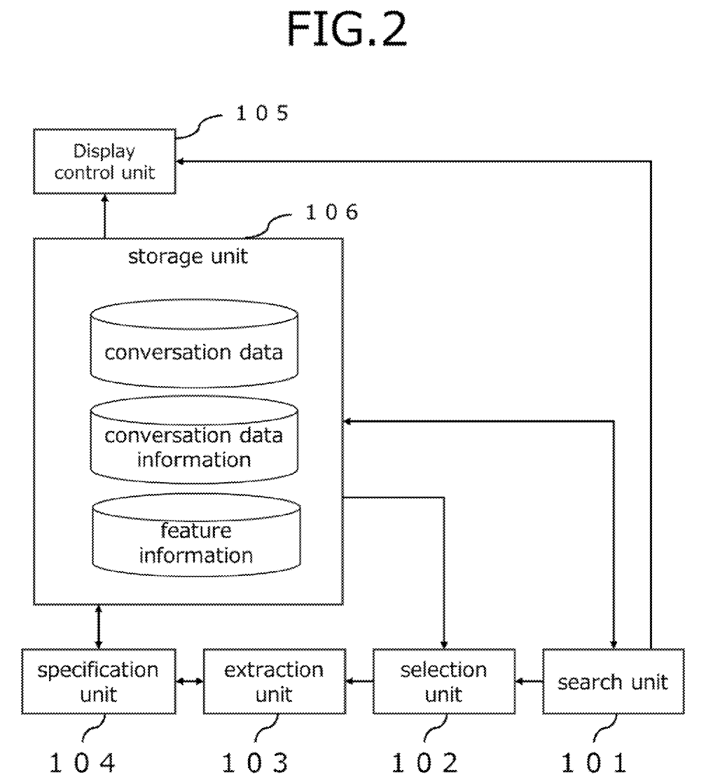

FIG. 1 is a schematic diagram illustrating a configuration of an information processing apparatus according to a first embodiment. FIG. 2 is a functional configuration diagram of the information processing apparatus according to the first embodiment. As illustrated in FIG. 1, an information processing apparatus 100 according to the first embodiment includes a search unit 101, a selection unit 102 (102a, 102b), an extraction unit 103, a specification unit 104, a display control unit 105, and a processing device 200. The processing device 200 includes a storage unit 106, an input interface (I / F) 110, an output interface (I / F) 111, a communication interface (I / F) 112, and CPU113, ROM114, RAM115, and system buses 116.

The search unit 101 receives a search condition related to the content of conversation data input by the user. The conversation data is related to a conversation in an electronic mail, for example. Here, the user inputs a search condition related to the feature label, and thus it is possible to search for conversation data corresponding to the search condition input by the user from the past conversation data. The search unit 101 sends the search result of the conversation data related to the search condition to the selection unit 102.

The feature label may be set in advance, and examples thereof include "phenomenon", "cause", "countermeasure", "result of countermeasure", "possibility", "individual opinion", and "inference". The user inputs a search condition related to the feature label of "phenomenon", and a feature corresponding to the feature label of "phenomenon" of the past conversation data is set as a search target. The user may input a search condition related to the feature label of "countermeasure", and a feature corresponding to the feature label of "countermeasure" of the past conversation data may be set as a search target. Alternatively, both "phenomenon" and "countermeasure" may be search targets by using an AND search.

The selection unit 102 refers to the storage unit 106 and acquires conversation data related to a problem that has occurred in a business operation and that is selected by the user from the search result.

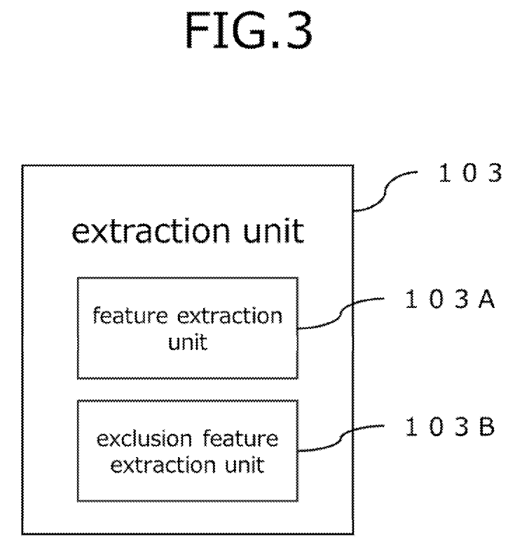

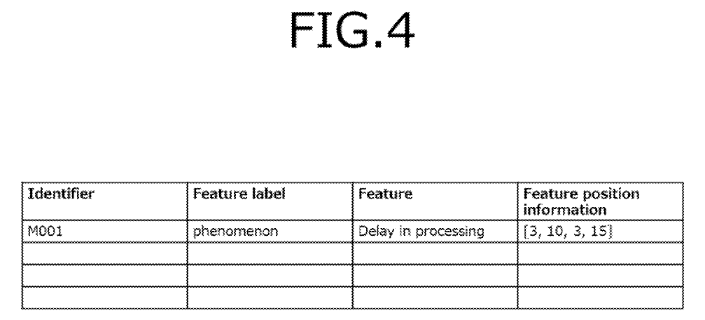

FIG. 3 is a schematic diagram illustrating a structure of the extraction unit 103 of the information processing apparatus according to the first embodiment. The extraction unit 103 includes a feature extraction unit 103A and an exclusion feature extraction unit 103B. The feature extraction unit 103A extracts feature information from the conversation data selected by the selection unit 102 and the related conversation data in the storage unit 106. FIG. 4 is a diagram illustrating a configuration of feature information according to the first embodiment. The feature information includes an identifier, a feature, a feature label corresponding to the feature, and feature position information. The identifiers refer to codes (for example, M001) assigned to identify the respective pieces of conversation information. The feature position information is composed of [the line number including the tag range start character, the position of the tag range start character in the line, the line number including the tag range end character, the position of the tag range end character in the line + 1]. By extracting the feature position information, it is possible to specify a portion where the feature is displayed in the conversation data.

The exclusion feature extraction unit 103B extracts the exclusion feature from the conversation data and does not display (excludes) the exclusion feature on a display unit (not illustrated). The exclusion feature refers to a feature corresponding to a predetermined feature label to be excluded, and is a feature to be excluded from the conversation data. The feature labels to be excluded (exclusion labels) include, for example, "possibility", "individual opinion", "inference", and the like. Further, as a feature related to the feature label of "possibility", there is "there is a possibility of an abnormality in the software" or the like. At this time, since "there is a possibility of an abnormality in the software" corresponds to the exclusion label of "possibility", it is extracted as an exclusion feature, but is excluded from the final display of the display unit.

Further, instead of defining labels such as "possibility", "individual opinion", and "inference" as feature labels, these features may be excluded using predetermined clue expressions to be excluded. The clue expression refers to a text string including an expression related to a possibility, a personal opinion, and an inference such as "I think …”,” there is a possibility of …” and the like in the conversation, and is an expression to be excluded from the final display is manually set. First, as exclusion labels, "possibility", "individual opinion", "inference", and the like are not set, and only feature labels to be displayed of "phenomenon", "cause", "countermeasure", and "result of countermeasure" are set. A sentence including a feature to which the set feature label is assigned may be extracted, and a sentence corresponding to the clue expression to be excluded may be excluded. For example, in the case of a sentence "there is a possibility of an abnormality in the software”, when only "phenomenon", "cause", "countermeasure", and "result of countermeasure" are set as feature labels, "abnormality in the software" is extracted as a feature corresponding to the "phenomenon" label. When "there is a possibility" is set as the clue expression, a sentence including the extracted feature, "there is a possibility of an abnormality in the software", matches this pattern. Therefore, the feature "abnormality in the software" corresponds to the feature label of "phenomenon", but since there is the clue expression "there is a possibility", the feature or the feature label is not extracted, and is excluded from the final display of the display unit.

The specification unit 104 extracts features in one conversation data selected by the user and the related conversation data by the extraction unit 103, and identifies a feature label corresponding to the extracted features. For example, the feature related to the feature label of "phenomenon" is displayed with a solid line frame and bold characters, the feature related to the feature label of "cause" is displayed with a dotted line frame, the feature related to the feature label of "countermeasure" is displayed with a solid line frame and italic characters, and the feature related to the feature label of "result of countermeasure" is displayed with a dashed-dotted line frame. The display method does not necessarily follow the above-described method, and the feature labels may have different appearances, for example, the feature labels may be distinguished by colors. The specification unit 104 refers to the conversation information in the storage unit 106, determines whether or not the one conversation selected by the selecting unit 102 includes the Reply-To information, and associates the conversation data with the related conversation data according to the citation relationship using the Reply-To information. The conversation data information includes at least an identifier, header information of an electronic mail, and information of a mail body (for example, a body portion of the electronic mail) in the case of conversation data related to the electronic mail, for example.

The ROM 114 stores a program necessary for causing the computer to implement the above-described processes.

The RAM 115 functions as a storage in which the program stored in the ROM 114 is loaded.

The CPU 113 includes processing circuitry. The CPU 113 executes a program stored in at least one of the ROM 114 and the storage unit 106 using the RAM 115 as a work memory. During execution of the program, the CPU 113 controls each component via the system bus 116 and executes various processes.

The storage unit 106 stores data necessary for executing the program and data obtained by executing the program. The storage unit 106 also stores conversation data selected by the selection unit 102. The storage unit 106 stores conversation data, conversation data information, and feature information. The storage unit 106 includes, for example, one or more selected from a hard disk drive (HDD) and a solid state drive (SSD). The feature information is information of a feature extracted from the body of the conversation data, and refers to an identifier of the conversation data from which the feature is extracted, a feature label corresponding to the feature, the feature, and feature position information.

The input interface (I/F) 110 connects the processing device 200 and the search unit 101. The input I/F 110 includes, for example, one or more selected from a mouse, a keyboard, a microphone (audio input), and a touch pad. The CPU 113 can read various types of information from the search unit 101 via the input I/F 110.

The output interface (I/F) 111 connects the processing device 200 and the display control unit 105. The output interface I/F 111 is a video output interface such as a digital visual interface (DVI) or a high definition multimedia interface (HDMI). The CPU 113 sends the display control 105 via output I/F111.

The communication interface (I/F) 112 connects the selection unit 102, the extraction unit 103, the specification unit 104, and the information processing apparatus 100 outside the processing apparatus 200. The communication I/F 112 is, for example, a network card such as a LAN card. The CPU 113 can read various types of information from the selection unit 102, the extraction unit 103, and the specification unit 104 via the communication I/F 112.

The display control unit 105 displays the search result (conversation data) acquired by accessing the storage unit 106 on the display unit in a different appearance based on the search condition received by the search unit 101. The display unit displays the related conversation data by the first display method or the second display method using the information of the specifying unit 104 and the storage unit 106. The first display method is a method of displaying one conversation data selected by the user from the search result, the related conversation data, and the features of the conversation data. On the left side of the screen, the conversation data selected by the user and the related conversation data are displayed in a tree shape in accordance with the citation relationship with the conversation data selected by the user as a starting point. The second display method is a method of extracting only features from the conversation data selected by the user and the related conversation data and displaying the features in a tree shape. This enables the user to efficiently confirm the description to be focused on.

The display control unit 105 outputs the data received from the output interface 111. The display unit is connected to the display control unit 105, and the display unit is configured by any one of a monitor, a printer, and a projector, for example. In a case where the information processing apparatus according to the present embodiment has a touch panel, it is conceivable that the touch panel has both functions of the search unit 101 and the display unit. In the above embodiment, the display control unit 105 may be mounted on a cloud or the like, and the above display may be performed on a display unit of a local device of the user.

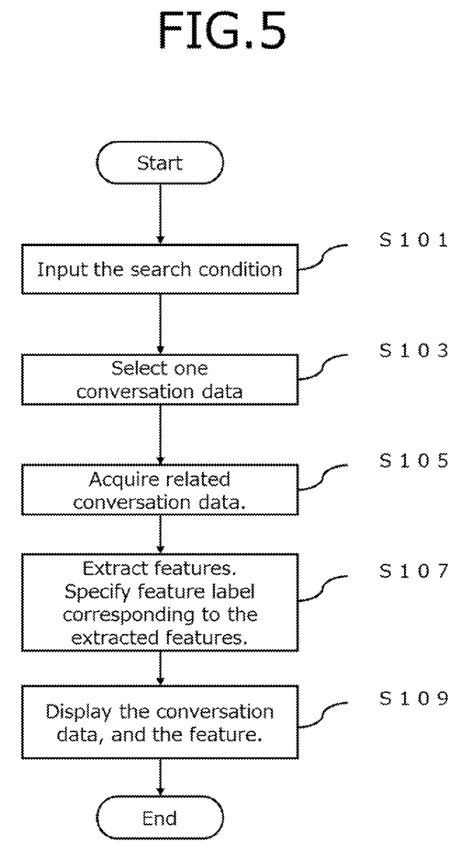

FIG. 5 is a flowchart illustrating an information processing method using the information processing apparatus according to the first embodiment.

### Step S101

The search unit 101 receives a search condition related to the content of conversation data input by the user. The search condition input at this time is the content related to the feature label of the conversation data, and for example, the search condition associated with the feature labels "phenomenon", "cause", "countermeasure", and "result of countermeasure" can be input.

### Step S103

The selection unit 102 refers to the storage unit 106 and acquires conversation data related to a problem that has occurred in a business operation and that is selected by the user from the search result.

### Step S105

The extraction unit 103 extracts feature information from the conversation data selected by the selection unit 102 and the related conversation data in the storage unit 106. The extraction unit 103 accesses the storage unit 106 and acquires feature information corresponding to the acquired conversation data information.

The extraction unit 103 also traces the citation relationship from the acquired conversation data information, and acquires a plurality of pieces of related conversation data related to the one piece of conversation data selected by the user. Tracing the citation relationship refers to tracing which conversation data is replied to by referring to Reply-To or the like included in the header information. The header information refers to information other than the data text of the conversation data, that is, the attribute of the conversation data, and refers to, for example, Message-ID, Reply-To, Date, From, To, and Subject of the electronic mail. The header information also includes an identifier.

The related conversation data includes all header information about the conversation data. All the header information refers to the header information of all the conversation data that can be acquired by tracing the citation relationship.

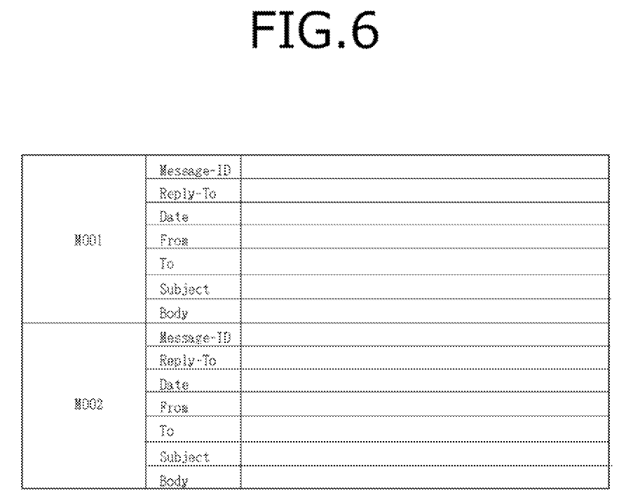

FIG. 6 is a diagram illustrating a configuration example of conversation data information according to the first embodiment. The mail body stores a mail body (only a newly added portion) acquired by identifying a reply source mail using the information of Reply-To and performing processing of taking a difference from the original mail in advance.

In FIG. 6, M001 and M002 indicate identifiers, and header information and mail text are displayed on the right side. Further, information of Message-ID may be used as the identifier. Body indicates the mail body, and the others indicate header information. The extraction unit 103 acquires a plurality of related pieces of conversation data corresponding to the conversation data selected by the selection unit 102, by tracing back the citation relationships or following emails in which the device itself is the source of the reply. The citation relationship of the conversation data is acquired by checking the information of Reply-To included in the header information. The storage unit 106 will be described later.

### Step S107

An extraction part 103 extracts features in one piece of conversation data selected by a user and related conversation data, and a specification part 104 specifies a feature label corresponding to the extracted features. In the present embodiment, in addition to the feature labels "phenomenon", "cause", "countermeasure", and "result of countermeasure" to be extracted, feature labels "possibility", "individual opinion", and "inference" to be excluded can also be defined. By using the learning data, features corresponding to these seven types of feature labels can be extracted from the conversation data as feature labels. The extraction unit can extract features not including the feature labels of "possibility", "individual opinion", and "inference" by extracting only features corresponding to one or a plurality of feature labels of "phenomenon", "cause", "countermeasure", and "result of countermeasure".

The types of feature labels may be four types of "phenomenon", "cause", "countermeasure", and "result of countermeasure", and after features corresponding to these types are extracted, the features may be excluded from the features by referring to predetermined exclusion features. The exclusion feature refers to a feature (text) that is manually set and is to be excluded from the conversation data without referring to a predetermined feature label that has been learned. When the feature does not correspond to the exclusion feature, the feature related to the conversation data is extracted as the feature label. For example, consider a case where a message "There is a possibility that no improvement is applied to ZZ software." leads to the extraction of “no improvement is applied to ZZ software" as a "cause" from the description. At this time, the extraction unit 103 acquires a sentence including a feature "no improvement is applied to ZZ software" and determines whether the sentence matches an exclusion feature. When the feature label exclusion condition includes "There is a possibility", a sentence including the extracted feature, "There is a possibility that no improvement is applied to ZZ software.”, matches the exclusion feature. Therefore, "no improvement applied to ZZ software" is excluded from the feature.

### Step S109

The display control unit 105 causes the display unit to display one conversation data selected by the user among the conversation data acquired by accessing the storage unit 106, the related conversation data, and the feature by a first display method, or causes the display unit to display the feature labels arranged in a tree shape by a second display method, based on the search condition received by the search unit 101, and the first display method and the second display method cause the display unit to display the feature with a different appearance for each feature label.

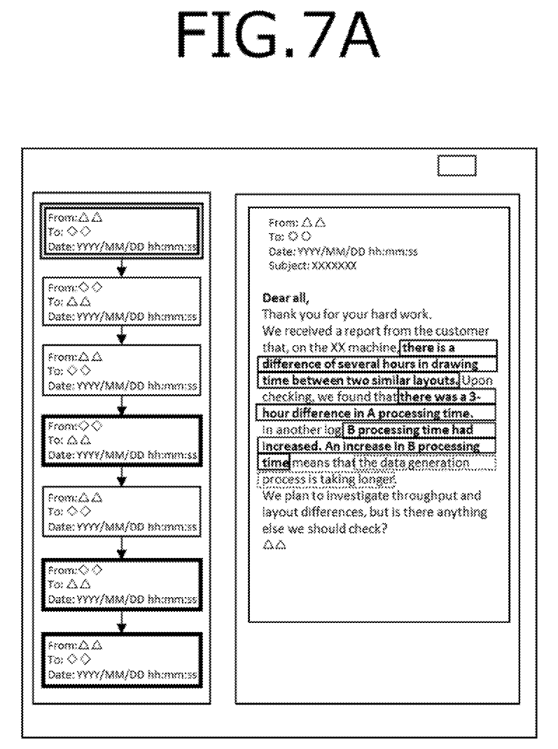

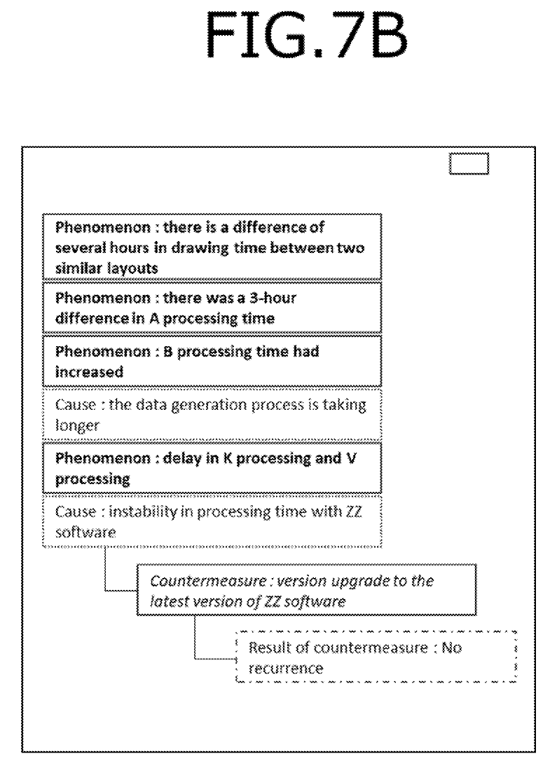

FIG. 7A and 7B illustrate examples of a display method of the information processing method according to the first embodiment. FIG. 7A illustrates a first display method. In FIG. 7A, the conversation data selected by the user is surrounded by a double line, and the conversation data including the feature is surrounded by a thick line. When the user selects one piece of related conversation data on the left side of the screen, the entire text of the conversation data is displayed on the right side of the screen, and when the feature is displayed, the feature label is displayed in a different appearance so that "phenomenon", "cause", "countermeasure", and "result of countermeasure" can be distinguished. In addition, in a case where the related conversation data includes a branch (in a case where there are a plurality of different replies to one piece of conversation data, or the like), the conversation data is displayed as conversation data branched in a tree shape.

FIG. 7B illustrates a second display method. Here, the above-described display method is used also when displaying the feature. The second display method starts with the feature label of "phenomenon", and ends with "result of countermeasure" through "cause" and "countermeasure". As in the first display method, when displaying the features, the feature labels are displayed in different appearances so that the "phenomenon", "cause", "countermeasure", and "result of countermeasure" can be distinguished. In addition, in a case where the related conversation data includes a branch (in a case where there are a plurality of different replies to one conversation data, or the like), the related conversation data is not displayed as one related conversation data, but is displayed as new related conversation data. The user can switch between the first display method and the second display method. For example, the display of each piece of related conversation data may be switched by a tab.

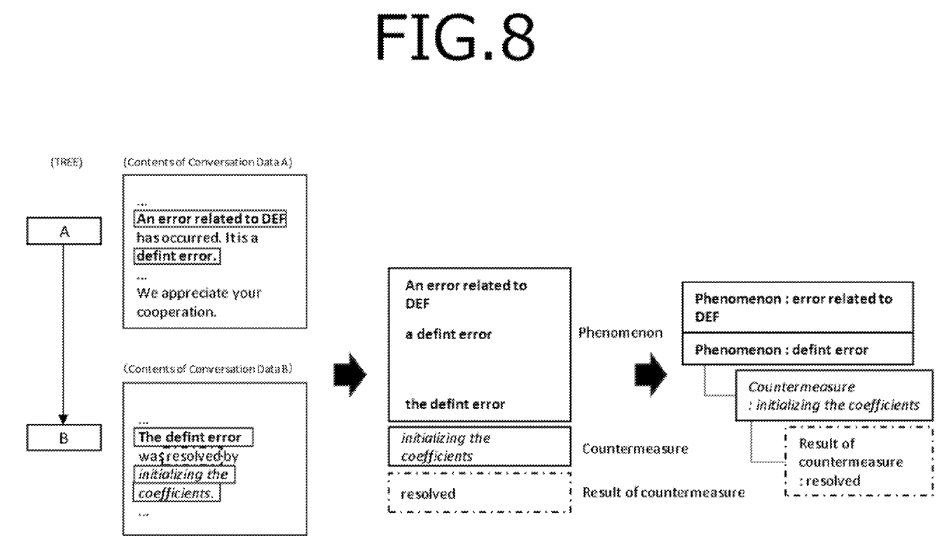

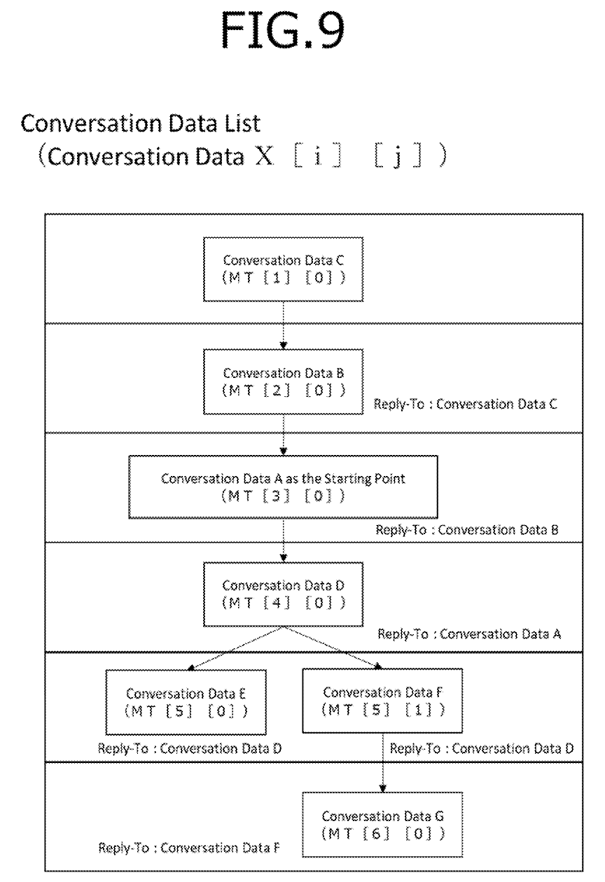

FIG. 8 is a diagram illustrating a generation example of a second display method of the information processing method using the information processing apparatus according to the first embodiment. In this example, it is considered that the tree is conversation data A → conversation data B. First, the conversation data extracted by the extraction unit 103 is arranged in a tree shape from the top in the order of appearance and is regarded as one document. The features and feature labels extracted by the specification unit 104 are extracted in the order of appearance, and the same consecutive feature labels are collected. When a plurality of the same texts appear in the same feature label, duplication is removed. Among these feature labels, a portion where the "phenomenon" and "countermeasure" labels are continuous or a portion where the "phenomenon", "countermeasure", and "result of countermeasure" labels are continuous is extracted and displayed. When the tree is branched, the tree may be divided into a plurality of partial trees without branches, and then a conversation data structure may be generated and displayed for each partial tree. For example, in the case of the tree shown in FIG. 9, the tree is divided into two partial trees of C → B → A → D → E and C → B → A → D → F → G, and the structure of the conversation data information shown in FIG. 7(b) is generated.

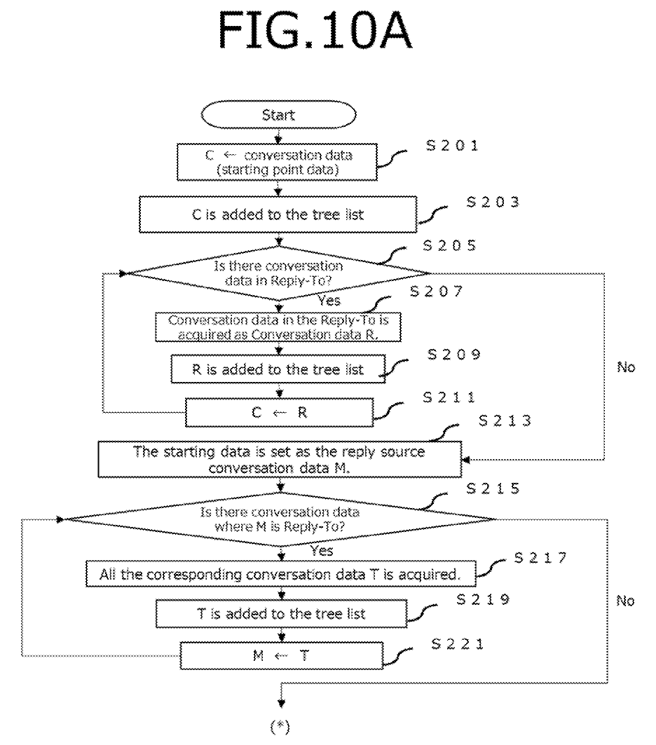

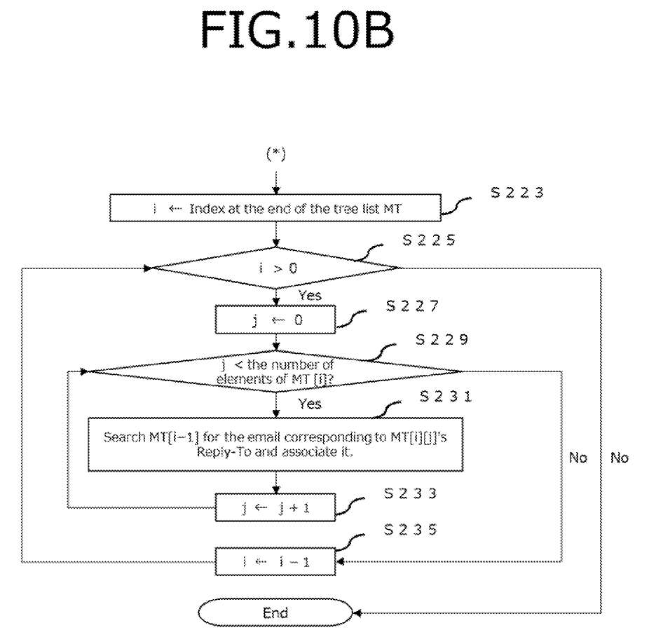

FIG. 10 is a diagram illustrating a flowchart of creation of a first display method and a second display method of an information processing method using the information processing apparatus according to the first embodiment.

### Step S201

The conversation data (starting point data) selected by the user in the selection unit 102 is denoted by C.

### Step S203

The text data C is added to the tree list. The tree list refers to a list of conversation data according to the first and second display methods to be created.

### Step S205

The specification unit 104 refers to the conversation data information in the storage unit 106 and determines whether or not the Reply-To of the conversation data C includes an identifier of another conversation data. When another conversation data is included in the Reply-To of the conversation data C, it is understood that the conversation data C is a reply of the other conversation data. The body of the conversation data may not be included in the Reply-To as long as the conversation data can be specified, and for example, the body of the conversation data may be included.

### Step S207

If it is determined in step S205 that the Reply-To of the conversation data C includes another conversation data, another piece of conversation data described in the Reply-To is acquired as a conversation data R.

### Step S209

The conversation data R is added to the head of the tree list.

### Step S211

The conversation data R is newly set as a conversation data C, and the process returns to step S205.

### Step S213

If the Reply-To of the conversation data C does not include another piece of conversation data at step S205, the starting data is set as the reply source conversation data M.

### Step S215

It is determined whether or not there is conversation data in which the conversation data described in the Reply-To information is the reply source conversation data M. When there is no conversation data that satisfies the condition that "there is conversation data in which the conversation data described in the Reply-To information is the reply source conversation data M" in step S215, the process proceeds to the process of step S223 and the subsequent steps.

### Step S217

In step S215, when there is conversation data that satisfies the condition that "there is conversation data in which the conversation data described in the Reply-To information is the reply source conversation data M", all the corresponding conversation data T is acquired.

### Step S219

All the corresponding conversation data T are added to the end of the tree list.

### Step S221

All the corresponding conversation messages T are set as new reply source conversation messages M, and the process returns to step S215.

### Step S223

In step S223 and subsequent steps, each conversation data in the tree list is ordered according to the citation relationship. First, the tree list is denoted by MT, and the index at the end of MT is denoted by i. The index at the end of the MT indicates “the number of hierarchies of conversation data included in the tree list -1”. The index i is an integer of 0 or more. For example, in the case of the tree list of FIG. 9, the number of hierarchies of the conversation data is 6, and therefore, the index i of the MT is 5.

### Step S225

A determination is made whether the index i of the MT is greater than 0. When i is 0 (“No” in step S225), the condition of i > 0 is not satisfied, then the process ends.

### Step S227

When i is 1 or more (“Yes” in step S225), each piece of conversation data in MT [i] is associated with the conversation data that is the reply source in the processing in step S227 and subsequent steps. First, the index j of the element in MT [i] is set to 0.

### Step S229

It is determined whether j is less than the number of elements of MT [i].

### Step S231

When j is smaller than the number of elements of MT [i] (“Yes” in step S229), the conversation data which is the j-th reply source in MT [i] is searched from the conversation data of MT [i-1] and is associated. For example, when the reply source of the conversation data G (MT [6] [0]) in FIG. 9 is searched, MT [5] is the target.

(Step S233)

Thereafter, j is incremented by 1, the conversation data which is the reply source of the conversation data of MT [i] is searched, and the process returns to step S229.

### Step S235

When j reaches the number of elements of MT [i] (“No” in step S229), i is decremented by 1, and the process returns to step S225. For example, in the case of FIG. 9, i is 5, and thus steps S225 to S235 are repeated until i becomes 0.

### Second Embodiment

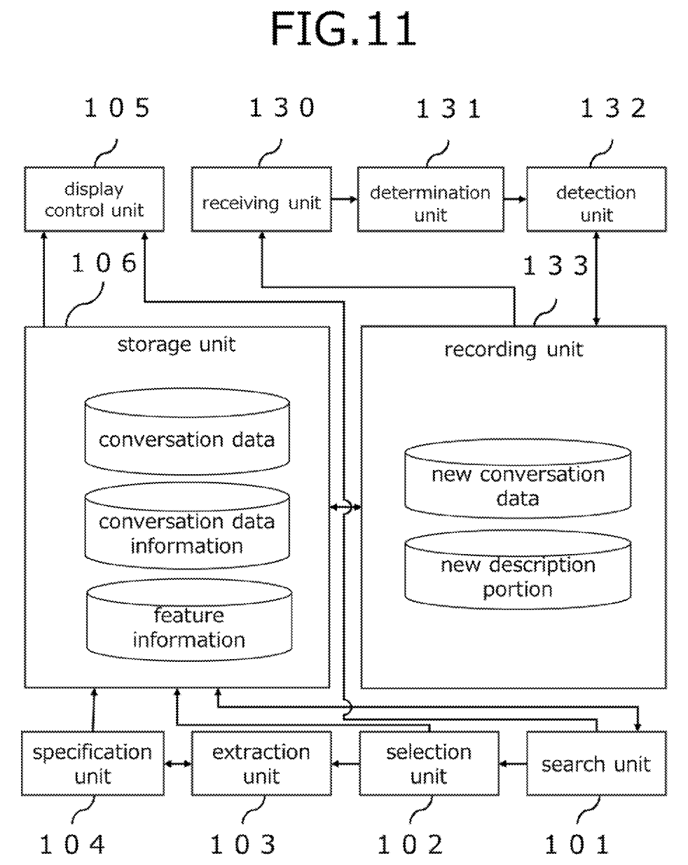

FIG. 11 is a functional configuration diagram of an information processing apparatus according to a second embodiment. The second embodiment is different from the first embodiment in that the second embodiment includes a receiving unit 130, a determination unit 131, a detection unit 132, and a recording unit 133 in addition to the functional configuration of the first embodiment.

The receiving unit 130 receives new conversation data from the recording unit 133. The reception of the conversation in the recording unit 133 may be performed by manually newly recording a set of conversation data, or by transferring new conversation data to the recording unit 133 when an external communication tool receives the new conversation data.

The determination unit 131 determines whether or not there is a new description portion based on the difference between the new conversation data and the related conversation data. The new description portion refers to a portion newly described in new conversation data.

The detection unit 132 detects a feature and a feature label corresponding to the feature from the new description portion of the determination unit 131.

The recording unit 133 generates feature information including the new conversation data and the new description portion. In addition, the new conversation data is added to the conversation data in the storage unit 106, and the conversation data information related to the new conversation data is added to the conversation data information in the storage unit 106. The feature information related to the new conversation data is added to the feature information in the storage unit 106.

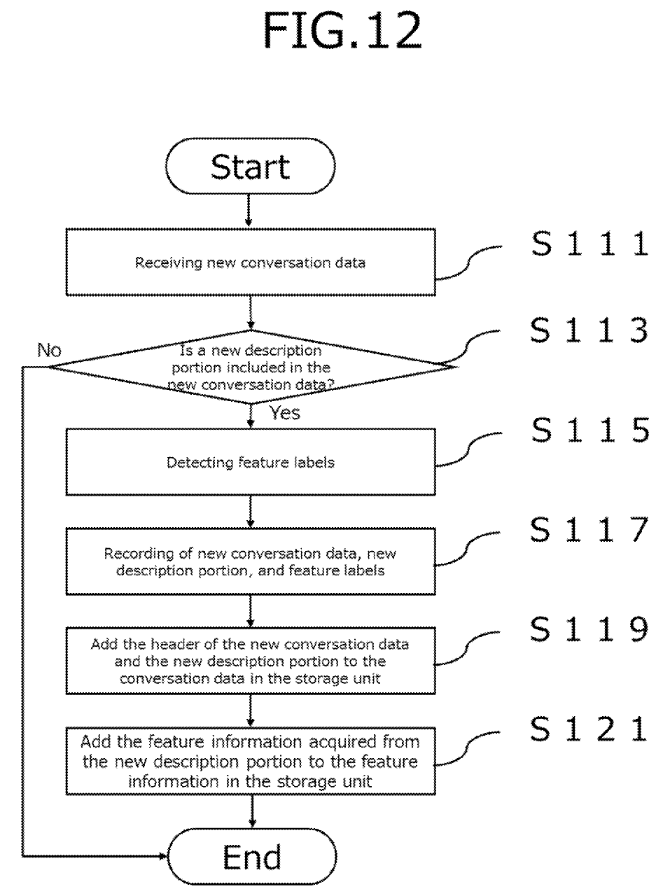

FIG. 12 is a flowchart illustrating an information processing method using the information processing apparatus according to the second embodiment. The second embodiment is different from the first embodiment in that steps S111 to S121 are added after step S109.

### Step S111

A receiving unit 130 receives new conversation data.

### Step S113

The determination unit 131 determines whether or not a new description portion is included in the new conversation data received by the receiving unit 130.

### Step S115

When a new description portion is included in the new conversation data received by the receiving unit 130 (“Yes” in step S113), the detecting unit 132 detects a feature of the new description portion and generates feature information.

### Step S117

The recording unit 133 creates conversation data by combining the header of the new conversation data and the new description portion, and adds the conversation data to the conversation data information. When the new description portion is not included in the new conversation received by the receiving unit 130 (“No” in step S113), the process is terminated.

### Step S119

The recording unit 133 refers to the storage unit 106 and adds a header and a new description portion of new conversation data to the conversation data.

### Step S212

The recording unit 133 refers to the storage unit 106 and the detection unit 132, adds the feature information acquired from the new description portion to the feature information, and the process is terminated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

What is claimed is:

1. An information processing apparatus that processes conversation data, comprising:
a first selection unit configured to select at least one of the plurality of pieces of conversation data,
a second selection unit configured to select related conversation data different from and associated with the conversation data selected by the first selector,
an extraction unit that extracts a feature corresponding to a predetermined feature label from the selected conversation data and the related conversation data,
a specification unit configured to specify the feature for each of the feature label,
a display control unit configured to cause a display unit to display the feature with an appearance different for each of the feature label, and
a storage unit configured to store the conversation data, the feature, and the feature label.

2. The information processing apparatus according to claim 1, further comprising
a search unit configured to receive an input related to the feature label of the conversation data.

3. The information processing apparatus according to claim 1, wherein the display control unit is configured to cause the display unit
to display the selected conversation data, the related conversation data, and the feature as a first display method,
to display only the feature extracted from the conversation data and the related conversation data as a second display method, and
to display the feature labels in different appearances in the first display method and the second display method.

4. The information processing apparatus according to claim 3, wherein
the first display method and the second display method by the display control unit are switchable.

5. The information processing apparatus according to claim 3, wherein
the conversation data and the related conversation data are displayed in a tree shape in the first display method and the second display method.

6. The information processing apparatus according to claim 3, wherein
the display control unit arranges the conversation data extracted by the extraction unit in order of appearance, and displays the features and the feature labels based on the appearance order.

7. The information processing apparatus according to claim 4, wherein
the display control unit arranges the conversation data extracted by the extraction unit in order of appearance, and displays the features and the feature labels based on the appearance order.

8. The information processing apparatus according to claim 5, wherein
the display control unit arranges the conversation data extracted by the extraction unit in order of appearance, and displays the features and the feature labels based on the appearance order.

9. The information processing apparatus according to claim 1, further comprising
a receiving unit configured to receive new conversation data,
a determination unit configured to determine a new description portion based on a difference between the new conversation data and the related conversation data,
a detection unit configured to detect the feature of the new description portion, and
a recording unit configured to record the new conversation data and the new description portion.

10. The information processing apparatus according to claim 1, wherein
the conversation data relates to a conversation in an electronic mail.

11. The information processing apparatus according to claim 1, wherein
the feature label relates to content classified into at least "phenomenon", "countermeasure", and "result of countermeasure".

12. The information processing apparatus according to claim 1, wherein
the extraction unit extracts a feature related to the related conversation data selected by the selection unit, refers to a predetermined exclusion feature, and extracts the feature related to the conversation data as an exclusion label when the feature does not correspond to the exclusion feature.

13. The information processing apparatus according to claim 1, wherein
the extraction unit extracts a feature related to the related conversation data selected by the selection unit, refers to an exclusion feature, and excludes the exclusion feature related to the conversation data when the conversation data corresponds to the exclusion feature.

14. An information processing method executed by an information processing apparatus, the method comprising:
selecting at least one of the conversation data,
selecting related conversation data that is other conversation data related to the selected conversation data,
extracting a feature corresponding to a predetermined feature label from the selected conversation data and the related conversation data,
identifying the feature for each of the feature labels,
displaying the feature on a display unit with an appearance different for each feature label, and
storing the conversation data, the feature, and the feature label.

15. A computer-readable recording medium storing a program that causes an information processing apparatus to execute a process comprising:
selecting at least one of a plurality of pieces of conversation data,
selecting related conversation data that is another conversation data related to the selected conversation data,
extracting features corresponding to a predetermined feature label from the selected conversation data and the related conversation data,
identifying the feature for each feature label;
Displaying the feature on a display unit with an appearance different for each feature label, and
storing the conversation data, the feature, and the feature label.
